(19) United States
(12) Patent Application Publication
(10) Pub. No.: US 2008/0126515 A1
(43) Pub. Date: May 29, 2008

(54) Advertising content management system and method

(76) Inventors: Gary Clark Chambers, West Hollywood, CA (US); Brian Robert Tefft, Gilbert, AZ (US)

Correspondence Address: GORDON & REES LLP, 101 WEST BROADWAY, SUITE 1600, SAN DIEGO, CA, 92101, US

(21) Appl. No.: 11/724,892

(22) Filed: Mar. 16, 2007

Related U.S. Application Data
(60) Provisional application No. 60/783,002, filed on Mar. 16, 2006.

(51) Int. Cl. G06F 15/16

(52) U.S. Cl. 709/218

(57) ABSTRACT

A system and method of managing advertisement content on websites and the like allows affiliates to create unique rich media advertisements using stored sponsor ads, videos, and graphic elements, to select website addresses to which each unique advertisement is to be directed, and to associate each unique advertisement and associated website addresses with an insertion code through which the advertisement is directed to the selected website addresses. The affiliate can modify an advertisement without changing the associated insertion code, so that the modified advertisement is automatically delivered to the selected websites.

### FIELD OF THE INVENTION

This invention relates generally to advertising content management systems and methods, and more particularly to systems and methods of managing advertisement content on websites that allow affiliates to create rich media advertisements using stored sponsor ads, videos, and graphic elements, to select website addresses to which each advertisement is to be directed, and to associate each advertisement and associated with an insertion code through which the advertisement is directed to the selected website addresses, the affiliate being able to modify an advertisement without changing the associated insertion code, so that the modified advertisement is automatically delivered to the selected websites.

### BACKGROUND OF THE INVENTION

The present invention relates generally to online advertising systems which insert advertisements on websites and the like when a user visits the site, and is particularly concerned with a management system and method for creating and managing the contents of such advertisements.

Online advertisers, also known as sponsors, use a variety of advertising methods to increase website traffic or visitors and sales. In addition to the typical advertising method of buying ad space on websites, sponsors are enlisting advertising partners, known as affiliates and also referred to as webmasters, to promote their products or services and pay fees based on their performance. Examples of performance tracking are pay-per-click, pay-per-impression, pay-per-join, pay-per-email or other personal information collected. Payment structures include a set amount for each sale, pay-per-click/visitor, or revenue share, in which a percentage of the sale is shared with the affiliate.

When an affiliate enrolls to promote a sponsor's product, they are given access to a variety of advertising resources. Examples of these resources include advertisement composites for use as web page banners, full page ads, animated or rich media banners, free content consisting of pictures or video of the sponsors product or service, hosted galleries containing pictures and videos for linking to, and other links that direct a potential customer to the sponsor's products, webpage or other medium where a purchase can be made when clicked from an affiliate webpage.

The resources currently available to affiliates and sponsors to manage and deliver advertisements throughout a system of websites do not differentiate between static and dynamic rich media ads. These systems are inefficient at delivering targeted advertisements during the website user's visit. This also prevents the sponsor or advertiser from offering its affiliates unique advertisements that would enhance the website. Current advertising systems do not allow the affiliate the ability to combine graphic and video elements to create a rich media advertisement that can be compiled and delivered by a remote server via an insertion code to a website visitor. Current advertising systems do not allow the affiliate to remove, append or otherwise modify rich media ads, video and graphic elements, destination URLs, affiliate IDs and the advertiser of an existing advertisement without changing the insertion code.

### SUMMARY OF THE INVENTION

It is an object of the present invention to provide a new and improved advertising content management system and method for managing online advertisements.

According to one aspect of the present invention, an advertising content management system is provided, which comprises a series of affiliates each having at least one website and an affiliate server associated with the or each website, at least one sponsor having at least one website and a sponsor server associated with the or each website, an advertising content management server associated with a website, a database associated with the advertising content management server, the advertising content management server comprising means for allowing an affiliate to combine a plurality of different elements to create a unique advertisement from elements offered by the advertising management system server and/or the sponsor server, means for associating a single insertion code with the unique advertisement created by the affiliate, and means for allowing the affiliate to modify the unique advertisement without changing the insertion code, whereby the modified advertisement is automatically provided to the affiliate's selected websites for delivery to users visiting the websites.

This system provides the affiliate with the ability to appoint or to designate the destination URL, the ads theme, or the advertiser at unique points throughout the rich media advertisements duration of play and static state. It also allows the affiliate to set specific limitations on how the media ad is broadcast, for example changing graphic and/or video elements after a predetermined time period if a user has not clicked on the ad. It may also keep track of whether a user is visiting the site for the first time or has visited before, or is visiting a second website of the same affiliate, in which case a different ad sequence can be broadcast.

The advertising management system server may be associated with a sponsor's website where the sponsor is managing the system, or may have its own associated website to provide a third party system which may be utilized by plural sponsors as well as affiliates.

According to another aspect of the present invention, a method of managing advertisement content on websites and the like is provided, which comprises the steps of:

storing website information, rich media ads, video elements, and graphic elements of one or more sponsors in an advertising manager;

allowing affiliates to create unique advertisements of selected sponsors using the stored information, rich media ads, video elements and graphic elements and to select the addresses (URLs) of websites on which the advertisements will be displayed; and

associating an insertion code with each advertisement created by an affiliate along with the URLs on which that advertisement is to be displayed.

Progressive and streaming videos may be selected based on settings predetermined by the affiliate. Rich media ads, videos and graphic elements stored in the advertising manager database can be associated with categories, niches, and demographics so that they may be searched and selected more readily by the affiliate. The affiliate can use the advertising manager to search and select advertisers or sponsors to promote, and then to create unique advertisements from the provided components for a selected sponsor, to be played on the affiliate's websites when accessed by users.

This system and method allows an affiliate to select various parameters for delivery of a unique rich media advertisement. The parameters may include which rich media ad to use, what graphic and video elements to incorporate, and what websites the ad will be played on. They can also specify a playlist for several advertisements.

The advertising content management system and method of this invention allows unique, targeted rich media advertisements to be delivered during a user's visit to a website, enhancing the overall experience. It also associates each advertisement with a unique insertion code, and allows the affiliate to modify the advertisement without changing the insertion code, so that the modified advertisement is automatically delivered to all selected URLs.

### BRIEF DESCRIPTION OF THE DRAWINGS

The present invention will be better understood from the following detailed description of an exemplary embodiment of the invention, taken in conjunction with the accompanying drawings, in which like reference numerals refer to like parts, and in which:

FIG. 1a is a block diagram illustrating an advertising content management system according to an exemplary embodiment of the invention;

FIG. 1b is a block diagram similar to FIG. 1 but illustrating a modified system in which the advertising content management server is incorporated into the sponsor's network and managed by a sponsor's system;

FIG. 1 is a screen shot illustrating a contact page of an advertising content management system according to an exemplary embodiment of the invention, the contact page having log in and contact information for a system sponsor;

FIG. 2 is a screen shot of another page provided by the system for adding new information to a sponsor's website;

FIG. 3 is a screen shot of a page for system operator entry of a new niche or site type to be added to the system;

FIG. 4 is a screen shot of a web page with an upload form containing input fields and default fields to specify default URLs for the banner and the site;

FIG. 5 is a screen shot of a page for loading and editing a new video file;

FIG. 6 is a screen shot of a page for associating a rich media ad, video and graphic elements with various categories, niches, and demographics;

FIG. 7 is a screen shot of an administrator page for setting limitations on user or affiliate accounts;

FIG. 8 is a screen shot of a page which allows a system operator to add an affiliate to the system;

FIG. 9 is a screen shot of a page allowing an authorized affiliate to view statistics associated with the advertising management system;

FIG. 10 is a screen shot of a page allowing an affiliate to search and select advertisers to promote on their website or websites;

FIG. 11 is a screen shot of a page allowing the affiliate to select parameters for delivery of rich media advertisements of the selected advertiser to play on their website or websites;

FIG. 12 is a screen shot illustrating a page allowing the affiliate to enter any insertion code to allow the parameters of any advertisement to be changed from within the management system without altering the insertion code;

FIG. 13 is a flow diagram illustrating the steps of the advertising content management system of the exemplary embodiment of the invention in creating insertion codes to be placed on websites; and

FIG. 14 is a flow diagram illustrating the steps carried out in delivering and displaying a rich media advertisement when a page containing the insertion code is viewed by a user.

### DETAILED DESCRIPTION OF THE EXEMPLARY EMBODIMENTS

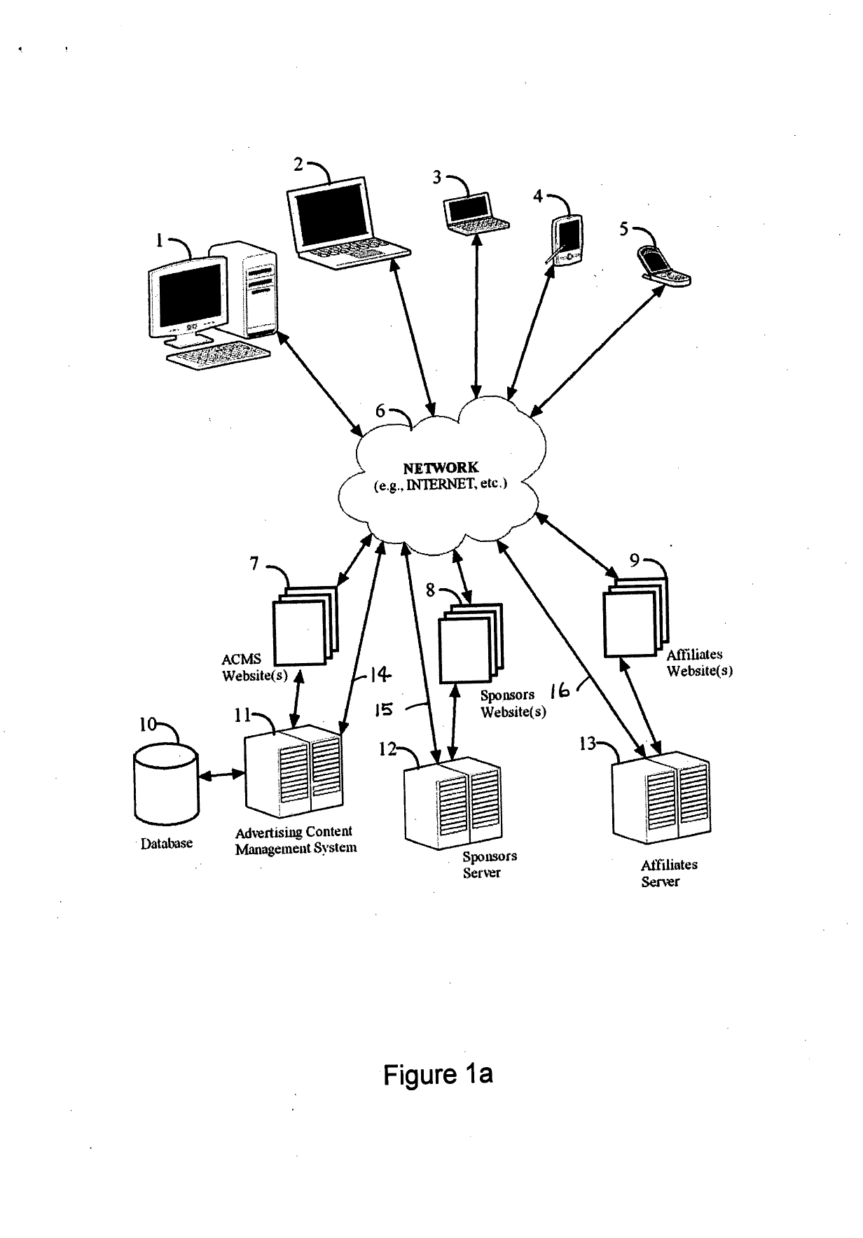

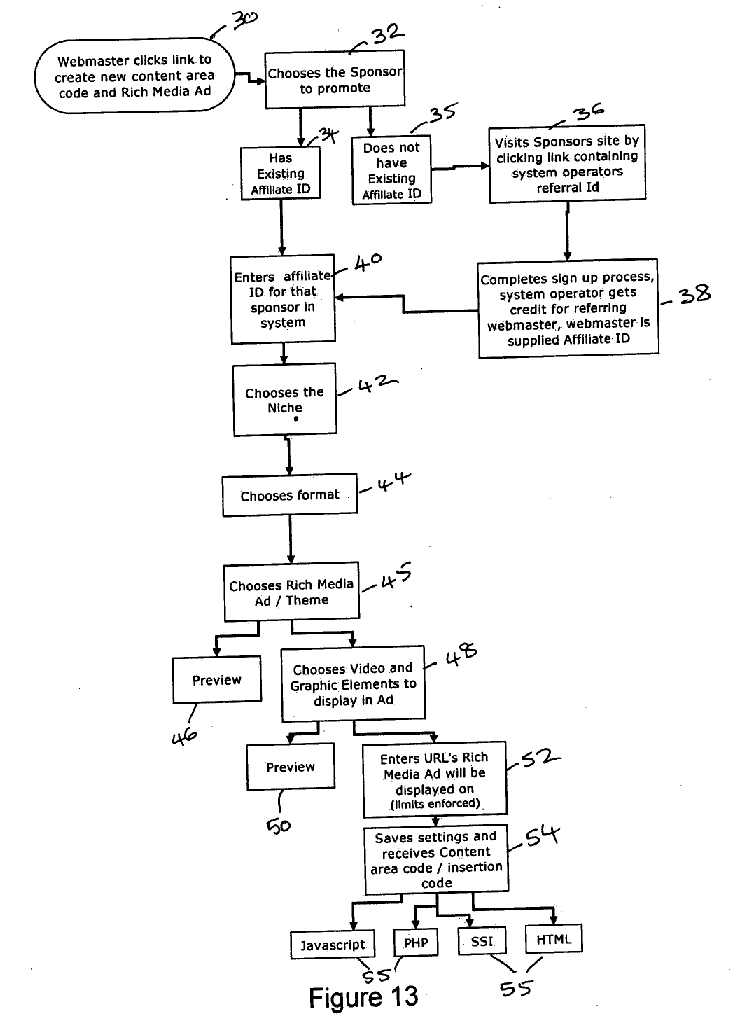

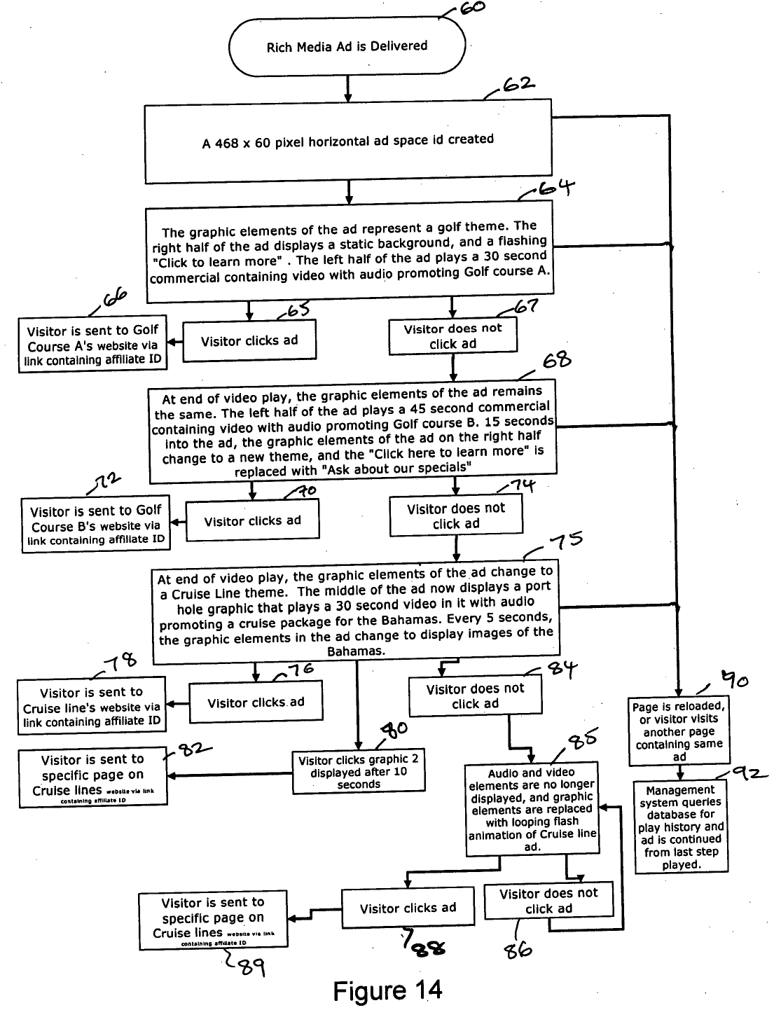

FIG. 1a is a block diagram of an advertising content management system according to an exemplary embodiment of the present invention, while FIG. 1b illustrates a modified system. FIGS. 13 and 14 are flow diagrams illustrating a method of controlling advertising content using the system of FIG. 1a or 1b,and FIGS. 1 to 12 are screen shots illustrating various screens presented for input by the system operator or affiliate in this method.

As illustrated in FIG. 1a, the system basically comprises sponsor server systems or sites 12, affiliate server systems or sites 13, at least one advertising content management server (ACMS) 11 which runs the advertising content management system, a database 10 associated with the advertising content management server 11, and user devices or target devices 1, 2, 3, 4 and 5 which can be used by users or members of the public to access the affiliate websites over a network such as the internet. As illustrated, the user devices may be desktop or non-mobile computers 1, laptop computers 2, 3, personal data assistants 4, cell phones 5 with internet access, other wireless devices or personal information devices, hand held devices, web tv, pocket pcs, and the like. However, the present invention is not limited to these electronic devices and other types of target electronic devices may be used to access and use the system.

Another embodiment of the management system can operate on the advertiser or sponsors' server systems, for the sole purpose of promoting only the advertiser who is the system operator, or a very limited number of advertisers or sponsors. This alternative is illustrated in FIG. 1b. In this embodiment, the advertising content management server 11 is connected directly to the sponsor's server 12, and there is no independent ACMS website. This embodiment is otherwise identical to that of FIG. 1a, and like reference numbers have been used for like parts as appropriate.

The target devices 1, 2, 3, 4, 5 are in communication with a communications network 6. The communications network 6 includes, but is not limited to, the World Wide Web, the Internet, an intranet, a wired Local Area Network (LAN), a wireless LAN (WILAN), a Wide Area Network (WAN), a Metropolitan Area Network (MAN).

The sponsor server(s) 12 publishes web pages 8 that are viewable to the target devices 1, 2, 3, 4, 5 via the communications network 6. The web pages can be for the same site or multiple sites. The sponsor's server can also interact with the affiliate's server 13 and the advertising content management system server 11 via the communication network 6. The affiliate server(s) 13 publishes web pages 9 that are viewable to the target devices 1, 2, 3, 4, 5 via the communications network 6. The web pages can be for the same site or multiple sites. The affiliate server can be a dedicated server used by that affiliate only, a server that is shared by many affiliates, or a server that is shared by multiple users regardless of whether or not the user is an affiliate of a sponsor associated with the advertising content management system. The affiliate is able to connect from a target device 1, 2, 3, 4, 5 to the advertising content management system website 7 via the communications network 6. Another embodiment allows the affiliate to administer their advertising content management system settings using a desktop application and transmit the setting and other required information directly to the advertising content system server 11 via the communications network 6. Another embodiment allows the affiliate to connect from a target device 1, 2, 3, 4, 5 to the advertising content management systems settings 11 incorporated into the sponsor's website(s), via the communications network 6, when the advertising content management system server is integrated with the sponsor's network, as illustrated in FIG 1b.

It is also contemplated that any one or more of the servers 11, 12, 13 may be indirect server-to-server communication with servers associated with target devices 1, 2, 3, 4, 5 through the communications network 6, bypassing the associated websites 7, 8, 9, as indicated by lines 14, 15 and 16 in FIGS. 1a and 1b.

The affiliate will place the advertising content management system insertion codes on page(s) of their website(s) 9 the rich media ads should be displayed on. When a page containing an insertion code is called to display on a target device 1, 2, 3, 4, 5, the insertion code will contact the advertising content management system server 11 via the communications network 6. The advertising content management system server 11 will query the database 10 to authenticate, track and process the request to determine what data needs to be returned to the requesting insertion code. The resulting data is transmitted back to requesting insertion code on the affiliate server 13. The insertion code will allow the server to process the received data and display the correct rich media ad, defined by the affiliate, on the affiliate website 9. When a user of a target device 1, 2, 3, 4, 5 clicks a link embedded in the rich media ad on the affiliate website 9, they will be directed to the sponsor's website 8, or specific page, as specified in the advertising content management system database record for that affiliate's insertion code, and the link the user clicked will contain the affiliate's ID code for that sponsor.

Another embodiment of the management system can be integrated with the advertiser or sponsor server systems for the sole purpose of promoting only the advertiser who is the system operator, or a very limited number of advertisers or sponsors. This alternative is illustrated in FIG. 1b. In this embodiment, the advertising content management server 11 is connected directly to the sponsor's server 12, and there is no independent ACMS website. This embodiment is otherwise identical to that of FIG. 1a, and like reference numbers have been used for like parts as appropriate. FIG. 1b illustrates the sponsor server 12 interacting directly with the content management system server 11, independent of the communication network 6; for example, via a direct connection, LAN connection, wireless connection, etc. Another embodiment can include the advertising content management system, advertising content management system database, or both, running on the same server as the sponsor website(s) and affiliate program.

The term “sponsor” as used herein refers to online advertisers who wish to advertise their products or services over the Internet. The term “affiliate” as used herein refers to webmasters who are enlisted as advertising partners of the sponsor or sponsors.

This rich media advertising content management system allows the user to combine various elements to create a unique advertisement from components offered by the system operator and/or sponsor. The advertisement is then displayed on the affiliate's web pages via a single dynamic insertion code which is placed on the websites by the affiliate. The insertion code is unique to the advertisement created by the affiliate through the system. Any of the elements of the original ad can be changed from within system and will automatically become active without altering the affiliate's websites and insertion code. The management system allows the affiliate to set specific limitations on how the media ad is broadcast including the rotation or change of specific elements. For example, the affiliate can specify that the video portion of the advertisement play once and upon completion play a second video clip or be replaced by a static graphical image. These changes in the broadcast ad can be triggered through the system by its tracking of several pieces of data. The data tracked includes such items as the number of displays of an element of the ad and of the ad in whole, the performance of the ad via number of click-throughs, and/or the amount of bandwidth used in the transmission of the ad. For example, upon the initial visit of the website user, the advertisement may play through an entire cycle of its graphical or video elements. Should the same user visit a different page, reload the same page, or visit a different site that uses the management system, a different series of elements may be broadcast, the same ad with different video components maybe broadcast, or a static version of an ad may be displayed. The management system allows through the same insertion code the ability to designate different advertisers or sponsors that the end-user will be directed to should they click on the ad. For example, the affiliate can specify different products or websites to deliver the visitor to depending on which element in the series of elements they click on. The managements system also allows the affiliate to change components and links of the ad when other specific components are displayed. For example, the affiliate can choose a video containing 5 different products. As each product is referred to in the video, in a separate area on the ad the graphics will change to elements related to the product in the video at that time. The destination URLs will also change with each product, so should the visitor click the video when the video is displaying product A, the visitor goes to URL specified for product A, then when product B is shown destination URL B is used and so on.

As noted above, the management system can be a remote system operating on Internet servers which are independent of the affiliate and sponsors server systems, and is then accessed by the affiliates and sponsors when using the system. This allows for tracking and administration of the advertisements without the need to alter or interfere with the operations of the affiliate or advertisers websites. Changes and new additions by the advertiser of advertisement elements are entered into the management system. For example; an advertiser would use the management system interface to make the addition of ad elements including video clips, graphical elements, or animations. These additions are then available to be included in new or existing advertisements at the affiliate's preference. The advertiser may also append the list of websites or products that an affiliate may choose to direct end-users to. For example, the advertiser may choose to allow the same video or graphical elements to be used to advertise different products or websites at the discretion of the affiliate. A similar embodiment of the management system can operate on the advertisers server systems with the same features as the independent version. In most cases this system would be for the sole use of promoting only the advertiser who is the system operator, or a very limited number of advertisers.

The affiliate will access the management system and select the products, websites or services they wish to promote from the advertiser(s) or sponsor(s) that they have created affiliate accounts with. For example, the affiliate may or may not choose to advertise all of the advertisers, products, or websites that are included in the management system. If the affiliate does not have an account with an advertiser but wishes to promote their product, the management system will provide a link the affiliate can visit to create an account. This link may or may not include the system operator's referral ID that will allow the system operator to receive credit from each sponsor for any impressions, clicks, sales or referrals resulting from a click thru from a link delivered from the management system that contains that ID.

The management system tracks any specific identification numbers, codes, or links that are assigned to each affiliate account. For example; an advertiser may assign each affiliate a unique identification code to include in any promotional HTML links or URLs. This code is commonly referred to as an affiliate ID. The management system associates these affiliate ID's with unique identifiers which are used by the management system to track any impressions, clicks, or sales or other captured data sent from the advertisement on the affiliate's website to the advertiser's websites, services and/or products. The clicks or activity to an advertiser or the advertiser's specific products and websites are reported to the affiliate when they access the management system. This reporting feature allows the affiliate to make changes to the advertisements based on the ad's performance. The data collected in the system can be reported and displayed to the affiliate according to variables such as specific time periods, individual advertisements, individual elements, and between single or multiple advertisers. For example, when an affiliate logs-in to the management system's administration area the collected data would be displayed using graphs, charts, tables, or other text and graphical means of display.

The management system tracks and compiles data for multiple users, multiple unique user identifiers, single or multiple advertisers and multiple advertisements. The management system is able set specific limitations on individual accounts or groups of accounts. Limitations can include: bandwidth used, impressions, click-throughs, advertisement elements available, number of advertisers selected, number of advertisements displayed or rotated, demographic limitations, and time periods. For example the management system can place a restriction on the number of video clips available or the number of advertisements that could be created for an individual affiliate's account in the system. Additionally, different types, account groups, or user levels can be specified within the management system so that individual affiliate accounts can be categorized and given a like set of limitations or specific identifying traits.

The management system can track click-throughs or activity on specific advertisements or affiliate accounts for the purpose of redirecting activity to websites, products or services of advertisers other than those selected by the affiliate when the advertisement or account was created or displayed. For example, if the products or websites the affiliate selected to advertise are no longer available or are not efficiently active due to technical problems or poor sales, the management system allows for system wide change diverting the click through traffic to different websites or products. Additionally, this feature could be used to divert users for the benefit, promotion or gain of the management systems administration.

The system operator can redirect a specified amount or a percentage of impressions, click throughs or other activity to advertisers, products or services other than those selected by the affiliate and can be used to divert users for the benefit, promotion or gain of the management systems administration. For example, the system operator can provide a free service for affiliates in exchange for redirecting a percentage of the affiliate's impressions or click throughs to the systems operators specified settings. If the products, services or websites an affiliate selected to advertise are no longer available or temporarily unreachable the management system allows for system wide change diverting the impressions and click through traffic to different websites or products. The management system tracks performance and payment history for each affiliate. Should an affiliate become inactive, or account fall past due, the management system provides an interface for the system operator to redirect individual components or all settings for that affiliate.

The rich media advertisement management system is designed to run on local or web servers and can be built from a variety of coding platforms, such as perl, C+, php, and uses a database, MySql or text files for example, for storage and retrieval of information. One example is a system coded in php and html using a MySql database, running on a Linux based web server running apache and associated server plug ins. Another example is a system coded in php and html using multiple text files to store data. The management system includes a secure area that requires users to log in to administer accounts and settings, and a portion of the management system is available to a non registered user. The ability to access certain areas of the management system or make certain changes depends on the users privileges as defined in the database. The system operator, or a user with admin privileges, creates a new record in the database for sponsor accounts. This interface can be a web based interface at a uniform resource locater address (URL). Other examples of the interface can include a desktop utility that is installed on the user's computer and interfaces with the management system using an internet connection.

FIG. 1 illustrates a screen shot of a typical database entry for a sponsor account. This database entry contains log in and contact information, for example company name, contact name, contact email, address, phone numbers, instant messenger info, program name, program URL, default URL for all ads, description of program(s), and a password and username to access the account. The management system operator will visit the Sponsors affiliate program site, complete the sign up process and obtain an affiliate ID for the sponsor's program. This affiliate ID is added to the database record under that sponsor for use in advertisements as well as affiliate referral links. This will allow the system operator to receive credit from each sponsor for any impressions, clicks, sales or referrals resulting from a click through from a link delivered from the management system that contains that ID.

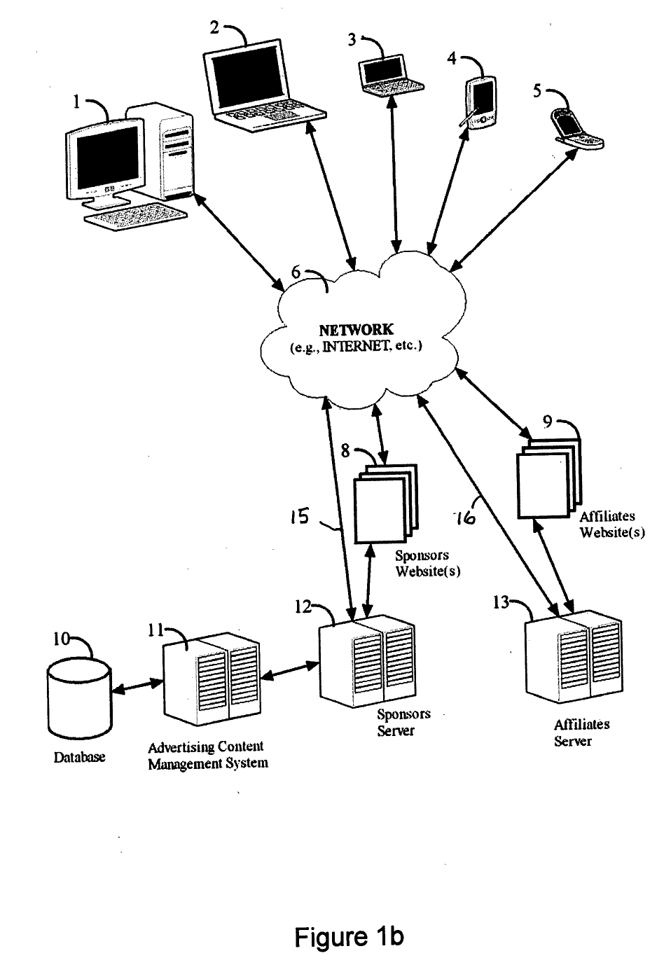

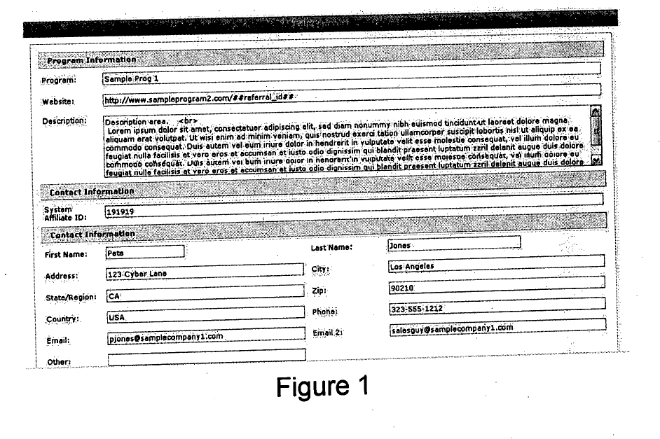

FIG. 2 illustrates a screen shot of a page used for creating a new website to be included in the management system. The system operator, or the sponsor, accesses a secure admin area using a previously created login to add the sponsor's website(s) information, rich media ads and video and graphic elements to the management system. Input fields in the admin area submit the information into the appropriate database fields, and the files are retrieved from the location specified in the admin area form and uploaded to the server. For example, the sponsor Fakename, Inc has the program ‘Widgets’ and has submitted the website “widgetsareus.com” to be included in the management system: After the primary database entry for ‘“Fakename, Inc’” has been created, the system operator logs into the admin area and adds the website “widgetsareus.com” to the database record for Fakename, Inc, and the website is listed among any other websites available for the program Widgets. Additional information can also be added here, such as description of the site, default URL, keywords, site type, ratings, payout rates, affiliate requirements and comments. Websites can be either set to active or inactive in the admin area by selecting or deselecting the respective field in the admin area of FIG. 2. Websites are also assigned to various niches and site types, for example via a check box next to each niche and type, as indicated in FIG. 2. Niches and site types are added/modified via the admin area by the system operator to allow for a comprehensive list (see FIG. 3). Affiliates and sponsors are able to submit a request via email or online support form to request niches or types to be added.

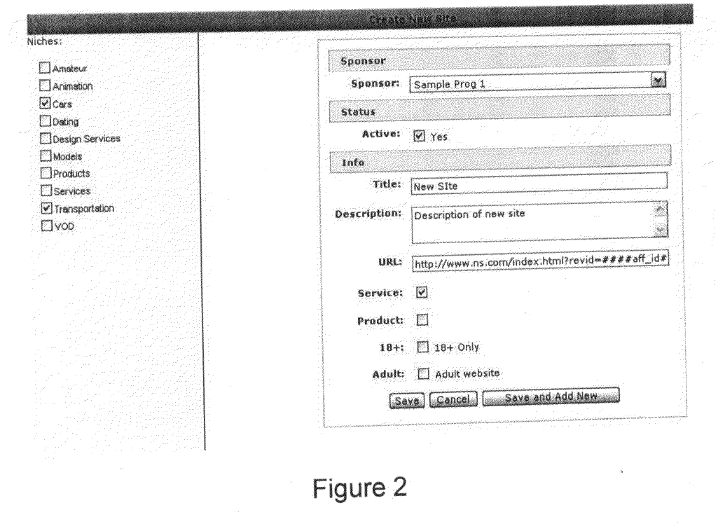

The system administrator, the sponsor, or any user with proper privileges as defined in the user database record uploads rich media advertisements and supporting graphics and video components to the management system. One example of this is via a web page with an upload form containing input fields, as illustrated in FIG. 4. File types of the rich media ads and the associated components will vary, and can include gif, jpeg, jpg, png, swf, mpg, mpeg, wmv, asf, tif, tiff, bmp, mov, flv, xml, smil, xaml, and actionscript. In one example, the file could be an swf file containing actionscript that links to an external xml file that instructs the ad to display graphicl.gif for 2 seconds, then video1.flv and video2.flv in that order, and then end_{—}01.jpg upon completion of the videos. Another example could include all components playing simultaneously in a suitable arrangement.

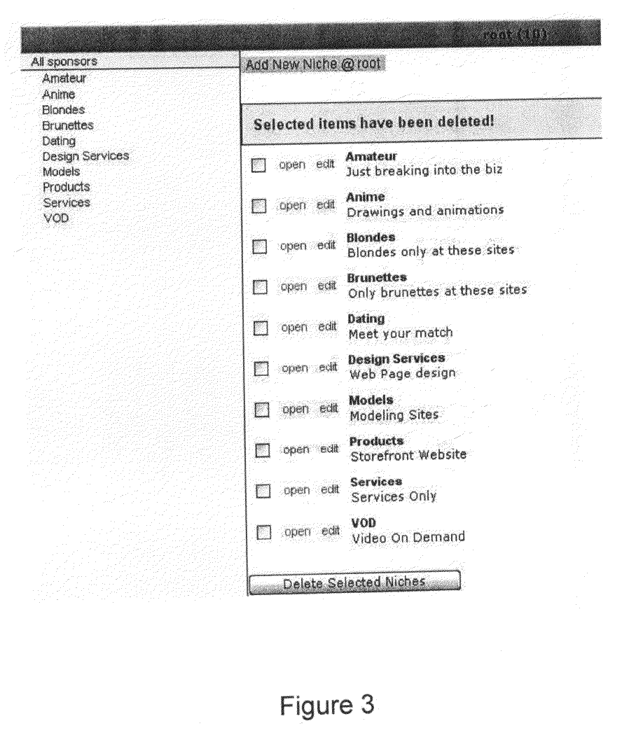

The management system incorporates the delivery of both progressive and streaming videos into the rich media advertisements based on settings predetermined by the affiliate and recorded in the affiliate's database record. The settings that are available to the affiliate are predetermined by the Sponsor or system operator. Video delivery can use a variety of methods and file formats including RTMP, HTTP, UDP, RTSP, Shockwave, Flash, Sparkle, Flex, MIDI, QuickTime, Beatnik, RMP, and MP3. Each video and graphic component can have multiple versions uploaded or residing on external servers and will have entries in the database associating it to the website(s), program, sponsor that component applies to and the location of the file. For example, a video intended for progressive http download could be uploaded in the following bit rates: greater than 512 kbps, 512 kbps, 256 kbps, 128 kps, 56 kps and 28 kpbs. FIG. 5 illustrates a web page form for this purpose. Each version could contain the same content or each version could be different, such as different scenes, video only on the lower bandwidth versions (no audio) or have different play lengths. Another example is a database entry in the management system that provides the path to a video component residing on an external server capable of adjusting the bandwidth of the video according to the users internet connection speed, such as Flash Communication Server, Flash Media Server, AJAX, Real Media or any protocol capable of proving such capabilities, for example RTMP.

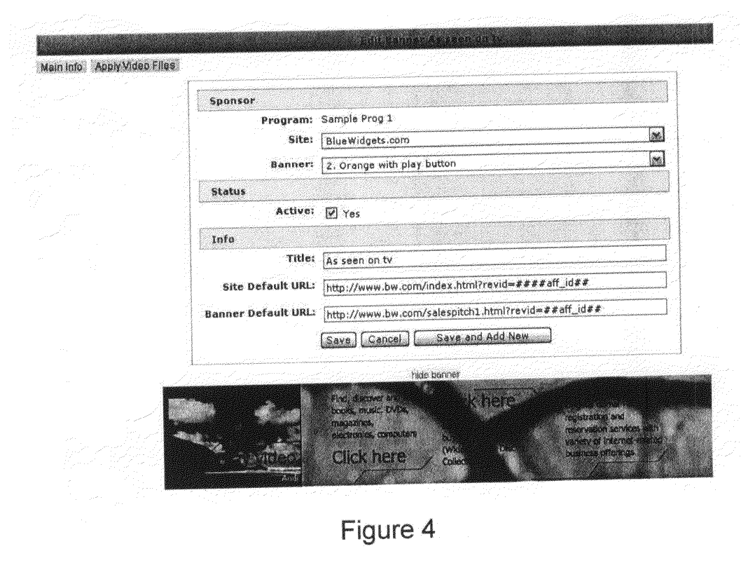

Rich media ads, videos, and graphic elements can be associated to categories, niches, and demographics by selecting or deselecting the respective fields in the admin area or inputting specific information. For example, video1.flv can be associated with ‘cars’ and ‘transportation’ niches. FIG. 6 illustrates a web page for associating a video with selected niches. Delivery of each rich ad and related content can be controlled by weekday, time, date, client IP, domain, client IP, language, browser, operating system, user agent, referring page and source. For example, Spanish browsers could be delivered the video component in Spanish, while English browsers could be delivered the English version of the video or an entirely different video. Video or graphic components can be previewed by clicking a preview link that is launches the media player required for that file type, and the rich ad can be preview in part or in whole. Ads and individual components can be set to active or inactive in the admin area by selecting or deselecting the respective field in the admin area.

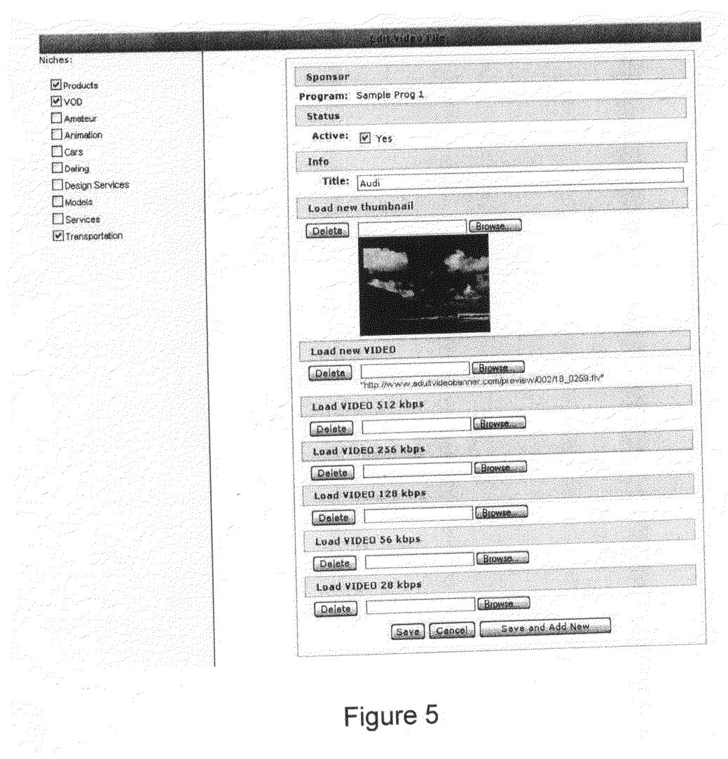

The management system is able set specific limitations on individual accounts or groups of accounts, also referred to as levels. A webpage for setting such limitations is illustrated in FIG. 7. The affiliates' and sponsors limitations are stored in the database record and the data is retrieved and reviewed by the management system whenever the management system performs a task for a user that requires level authentication. Limitations can include such items as bandwidth caps, total number of content area codes an affiliate can have, the total number of videos an affiliate can activate for each content area code, the total number of graphic components an affiliate can activate for each content area code, how many videos can play in a row on page load per banner, how many videos will play on that page load in total, targeting what locations the rich media ad can be displayed to, the number of impressions allowed per content area code per sponsor and per account, allowed number of advertisers selected, allowed number of advertisements displayed or rotated, and percentage of impressions or clicks redirected to the system operators settings. For example, an affiliate is assigned level 1. Level 1 parameters as defined by the system operator limit the affiliate to create a maximum of 10 content area codes, each content area code can only have up to 10 videos and 3 graphics components associated to it, only 3 content area codes can be used per page, up to 5 videos can play in a row per rich media ad and 10% of the click throughs will be redirected using the system operator's affiliate ID. Additionally, different types, account groups, or user levels could be specified within the management system database so that individual affiliate accounts could be categorized and given a like set of limitations or specific identifying traits. The particulars of each level are modified by the system operator via the admin area, or editing a configuration file manually and providing values for each field. The system operator can also create new levels via the admin area by creating new database entries containing each requirement and field for the value, any pricing requirements, and how that level should be assigned.

The management system allows the system operator to redirect a specified amount or a percentage of impressions, click throughs or other activity to advertisers, products or services other than those selected by the affiliate. Each level can have a different percentage or amount or the amount can be set on a per affiliate basis or by groups. When a rich media ad is displayed, the redirect setting data is retrieved and reviewed by the management system and the specified rich media ad containing the redirected URLs is displayed if called for. If the products, services or websites an affiliate selected to advertise is no longer available or temporarily unreachable the management system allows for a system wide change diverting the impressions and click through traffic to different websites, products or advertisers. The management system tracks performance and payment history for each affiliate. When an affiliate becomes inactive based on setting defined by the system operator in the admin area, or the account falls past due, the management system provides an interface for the system operator to redirect individual components or all settings for that affiliate.

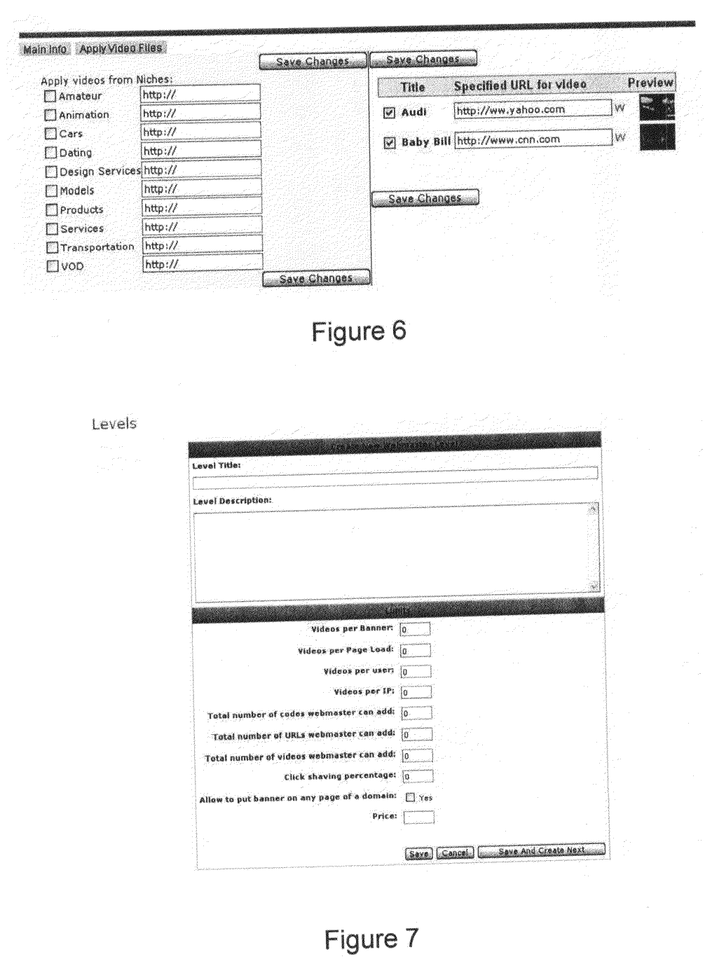

The affiliate or surfer accesses the unsecured front end of the management system through a website URL. The front end consists of web pages promoting the management system, for example sales materials, demo area, faqs, pricing. To access the admin area, and to create the insertion codes to be placed on any website by the affiliate, the affiliate is required to create an account for the management system. This process creates a new record in the database containing the affiliate's contact and site info. For example the company name, contact name, contact email, address, phone numbers, instant messenger info, URLs the management system will be used on, and payment information if required. System operators can also manually add an affiliate using the webpage illustrated in FIG. 8. Upon submission, the management system queries the configuration settings to determine if the account should be automatically or manually approved. If set to manually approve, the system operator or admin will be notified and required to manually activate the account. If the configuration settings entry is set to automatically approve the account, the account is active instantly. If levels are defined in the management system, the configuration settings will instruct the management system to review the information supplied by the affiliate and assign the appropriate level based on the parameters contained in the management system. For example, the configuration settings could specify to automatically approve all accounts and assign a default level specified, such as level one. In a second example, the configuration settings could specify that affiliates are assigned different levels based on selections they have made during the sign up process, or different levels assigned if the information they supplied meets certain criteria defined for each level. The sign up process can be integrated with a payment processing script, and the approval and levels can be based on which payment option the affiliate selected. For example, the management system owner can offer a free service that automatically approves a new affiliate but grants very limited privileges, while also offering five payment options, each with its own cost and each option providing a different level with its own custom set of privileges as defined in the database entry. The affiliate that chose the free version has the ability to transition the account from a free version to paid version by completing billing information, and the affiliate's record in the database would be updated to reflect the payment information and the new level.

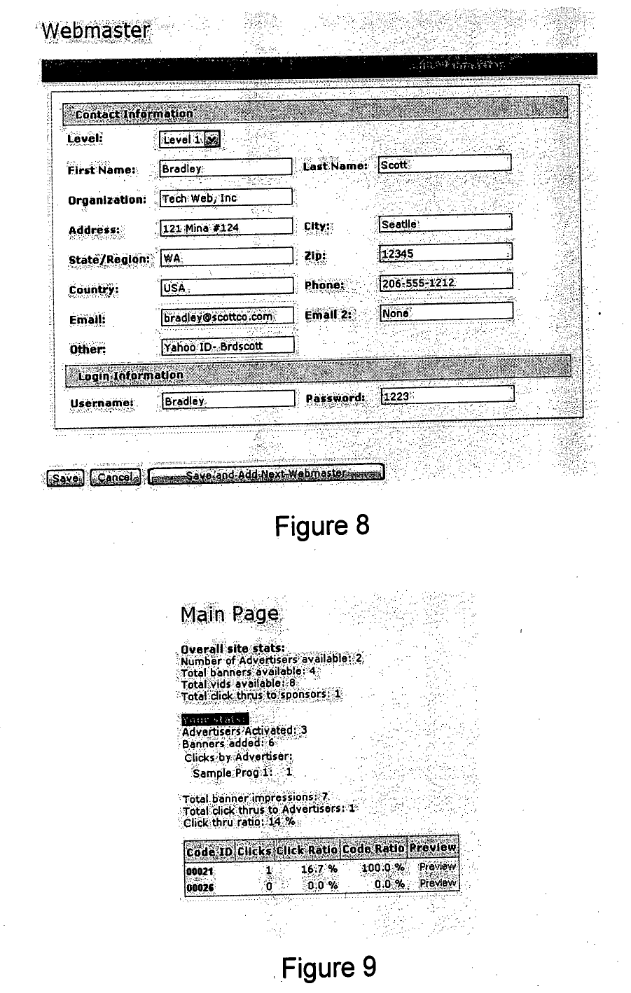

Once a new account is approved and the login created, the affiliate can log into the admin area to view statistics, as illustrated in FIG. 9, and administer account settings. This log in can take place via a web page, or from a desktop application. Detailed performance statistics collected for the affiliate's account will be retrieved from the database and presented to the affiliate upon successful login. The data collected in the system can be reported and displayed to the affiliate according to variables such as specific time periods, individual rich media ads, per graphic and video element, individual insertion codes, ratios, and single or multiple advertisers. These statistics can include: number of rich media ads created, number of advertisers selected, number of rich media ads displayed or rotated, number of videos selected, number of videos available, number of graphic elements selected, number of graphic elements available, and bandwidth used. The management system will log and display detailed impression and click through reporting of each rich media ad in whole or in part. For example: Rich media ad 1 received 100 impressions in total, however the two videos that were displayed in Rich media ad 1 received 30 impressions each, the second video received 20 click throughs to the sponsors program and graphic 1 received 40 impressions and 10 click throughs to the sponsors program. Length of viewing time per component and rich media ad as whole (if applicable) will also be logged and reported. The management system also provides detailed statistics per content area code. For example, the affiliate can log into the management system and review the statistics on number of click throughs on content area code 001. If this, content area code has low click throughs, the affiliate can review the statistics to see if one video has a better click through ratio than another. For example, the affiliate could remove the poorly performing video from the delivery of the ad by de-selecting it in the admin. The affiliate can then add 2 new videos by selecting them individually in the admin, assign them to play in a certain order or randomly, save the changes to the database and the new settings will automatically become active without having to alter the insertion code. The management system will also log statistics to the database that are only available to the system operator or sponsors, including the number of active affiliates, performance details of rich media ads and rich media ad elements across multiple affiliates including impressions, click throughs, click through ratios, viewing length, ratio of individual ad or component use compared to all available rich media ads.

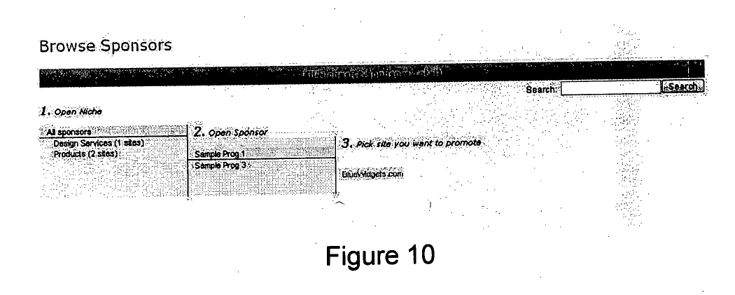

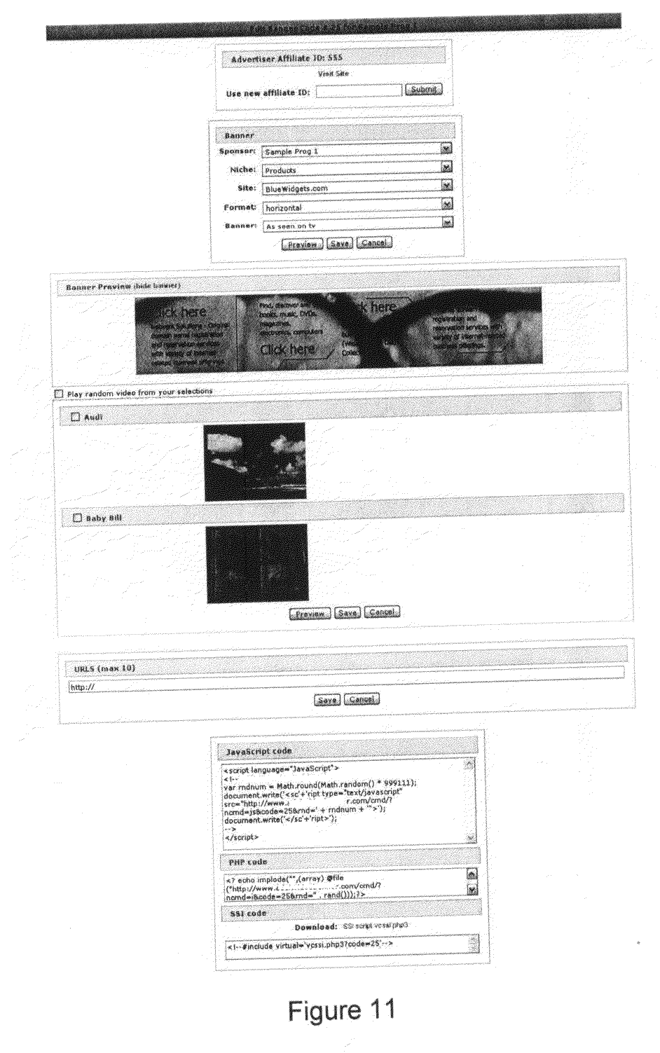

The affiliate will use the management system admin area to search and select advertisers to promote, as indicated in FIG. 10. Search criteria will be stored in the sponsors database record and can include, program name, site name, site niche, ad format, ad type, payout rate, productivity, and active promotions. As indicated in FIG. 11, the managements system provides a field for the affiliate to input their affiliate ID (Also referred to as account number, user ID, tracking ID; basically any value assigned to the affiliate to allow Sponsor to track affiliates performance) for each sponsor and records it in the affiliate's database record. If the affiliate does not have an existing affiliate ID with the selected sponsor, the management system provides a link for the affiliate to use. This link is recalled from the sponsors database record and uses the sponsor's affiliate referral URL containing the system operators affiliate ID to ensure the system operator receives credit for the referral. Other examples could also link directly to the sponsors program without a referral ID or link to a third party service.

The affiliate will access the management system admin to create the insertion codes to be placed on websites. One example of this process is illustrated in FIG. 13. The webmaster or affiliate first clicks the link to create a new content area code and rich media ad (step 30). They then choose the sponsor to promote (step 32). If they have an existing affiliate ID, they enter it at step 34. If they do not yet have an affiliate ID (35), they visit the sponsor's site (step 36) by clicking on a link, and then complete the sign up process (step. 38) and receive an affiliate ID for that sponsor. The affiliate ID for that sponsor is then entered in the system (step 40), the niche is chosen (step 42), along with the format (step 44). The rich media ad to be promoted for that sponsor is then selected (step 45), and the ad is previewed (step 46). Video and graphic elements to be displayed in the ad can be selected (step 48), using the screen of FIG. 11, and a preview of the revised ad is displayed (step 50). The URLs on which that ad will be displayed are then entered (step 52). The settings are then saved, and the content area code/insertion code is provided (step 54). The user can select the format that best fits the needs of the website the link will be placed on, for example Javascript, php, ssi, html, or others. Some of these options are illustrated in selection boxes 55 by way of example in FIG. 13.

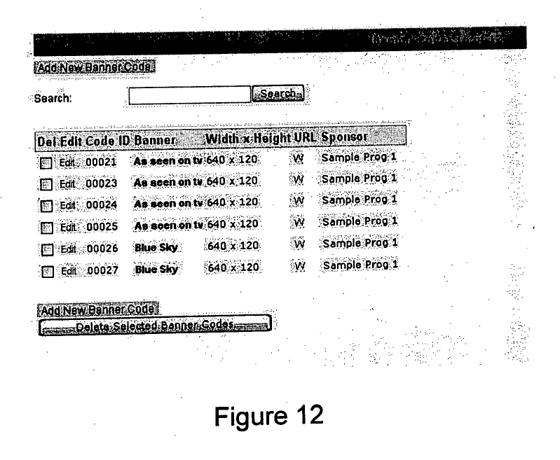

The insertion code can request information, images, applications, banners, media content, and browser scripts. The affiliate will click a hyperlink and the management system will create and record a unique ID, also referred to as content area codes and banner codes, to be used for that insertion code and record it in the affiliate's database record (see FIG. 12). The management system will then create and present the affiliate the insertion code that the unique ID refers to. Every link code may use several programming languages thereby allowing the affiliate to choose the format that best fits the needs of the website the link will be placed on (see step 54 of FIG. 13). For example: php, JavaScript, ActionScript, ssi, txt, iFrame, html, xml, smil, xaml, asp, and technologies (for example, DHTML, Flash, Sparkle, Flex, AJAX). The insertion code may also send requests on events (for example, on load, on surfer button click, on the rich media event, on surfer browser event).The affiliate will, choose one of these formats and place the insertion code on the webpage(s) the rich media ads should be displayed on.

The insertion code may use several requests to the management system depending on its type. For example, affiliate's host allows scripting and affiliate uses server side version of the insertion code. In this case affiliate's server side script sends surfer browser environments to the management system and requests code from the management system remotely. The management system will return code, and returned code will be sent to surfer's browser and the browser may have additional scripting to process to complete requests to the management system. Another version of the management system will use the browser's request and browser's environments to recognize which ad to display. For example, the management system detects the URL the insertion code is on and the surfer's location and displays the rich media ad assigned to that URL/location in the affiliate's database record.

The affiliate will select the parameters to use for delivery of the rich media ad as indicated in the flow diagram of FIG. 13. This includes which rich media ad to use (step 45), which graphic and video elements to incorporate into the rich media ad (step 48), and what URLs the ad will be displayed on (step 52). The insertion code can also be generated after the parameters have been identified. For example, the affiliate could log into the management system admin area, choose the sponsors program they wish to promote, provide their affiliate ID (if not previously entered) or modify the existing one, select the rich media ad, niche, site to promote, ad format and videos and graphic elements to include. Once the above parameters are selected, the management system will write the selections to the affiliate record in the database, reference them to the unique ID, and provide the insertion code options.

When the page containing the insertion code is viewed, the management system receives the insertion code, looks up the parameters assigned to the content area code in the database, and delivers a rich media ad containing the correct graphics, videos and hyperlinks with embedded affiliate IDs. One example of this process is illustrated in FIG. 14. Any of the elements of the ad can be changed from within the management system and will automatically become active without need to alter the insertion code(s). The affiliate logs in to the management system admin area and selects a hyperlink that queries the database and returns a list of active content area codes assigned to that affiliate. The affiliate selects an insertion code (FIG. 12), and the database returns the assigned parameters and graphic and video elements along with related statistics. The affiliate can modify, add or delete any parameter, including the affiliate ID, sponsor, niche, site to promote, target URLs, format, rich media ad design, play list order and URLs the ad will be displayed on (FIG. 11). The affiliate levels will determine what parameters and content are available.

The affiliate can place one or multiple insertion codes on a webpage. When a webpage containing multiple insertion codes is displayed, the management system will provide the rich media ads, videos, and graphic components in the order called, as play length determines, or as specified in the affiliate's database record. The management system will track and record all statistics of the ads, for example which ads displayed, which graphic components were displayed, which video components were displayed, number of times each component played, individual play length, and number of click throughs delivered to each sponsor. If the rich media ad calls for user interaction or input, these details are also recorded. The management system will query these records each time a rich media ad or component is called to prevent the same ad or component from showing on the page at the same time as well as to allow levels to be enforced. For example, the affiliate can have a webpage containing two insertion codes. When the affiliate created the content area codes assigned to those insertion codes, the affiliate chose one rich media ad for each, and for each rich media ad four videos that will play in the order specified. The affiliate is level X, which only allows four videos per page. When the page containing the 2 insertion codes is displayed, the management system will provide the specified rich media ads and video components. Once four videos have played, regardless of which ad, the limitations will prevent any additional ads from displaying until the page is reloaded. In this example, it would take two page loads for the surfer to see all eight ads.

FIG. 14 illustrates one possible ad sequence which may be associated with an insertion code. The rich media ad associated with that insertion code is delivered to the webpage (step 60), and an ad space is created (step 62). The ad is then played (step 64). In the illustrated example, the ad has a video commercial on one side and a flashing “click to learn more” on the other side. If a visitor clicks the ad while it is playing (65), they are sent to the associated website (66) via a link containing the affiliate ID. If they do not click the ad (67), the graphic elements change to a new theme and the words displayed are changed (step 68). If the new ad is clicked (70), the user is sent to another website associated with the new ad (72). If the visitor does not click on the ad (74), the graphic elements change to a new theme (75). In this case, the visitor is directed to a different page based on when they click on the ad. If they click during an initial portion of the ad (76), they are directed to the advertiser's website (78). If they click after a second graphic element is displayed in the ad (80), they are sent to a specific page on the advertiser's website (82). If the visitor does not click on the third ad (84), the audio and video elements are no longer displayed, and the graphic elements are replaced with something different, such as looping flash animation of the general theme of the ad (85). This continues as long as the visitor does not click the ad (86) or leave the website. If the ad (85) is clicked (88), the visitor is directed to a specific page on the advertiser's website. (89) If the page is reloaded at any time or the same visitor visits another page containing the same ad (90), the management system queries the database for play history (92), and the ad is continued from the last step played.

If the management system is unable to locate the rich media ad specified in an affiliate's database settings or if there is an error, the management system can display the default ad specified in the database for the website the original ad was intended or a default ad for that insertion code banner (FIG. 4).The system operator can also enable the management system to query the database for a similar ad or website and substitute the resulting ad for the ad that is unavailable. The system operator, payment processor, or sponsor can suspend an affiliate account via the admin area by enabling a suspend, field on the affiliate's database record that will enable the management system to redirect the insertion code to the new rich media ad specified by the user suspending the account, or substitute an alternate affiliate ID. For example, the affiliate John Doe created a rich media ad that delivers click throughs to widgetsareus.com. When this account falls ninety days past due, the affiliate ID contained in the rich media ad will be replaced with the system operators affiliate ID. All sales resulting from this ad will be credited to the system operator's account for that sponsor.

The management system incorporates a variety of security procedures to prevent abuse. Each content area code in the affiliate's database record has entries for every URL the insertion code that corresponds to that content area code is on. These URLs are input by the affiliate via a form field in the admin area when the content area code was created (FIG. 11), added when the affiliate modified the parameters of the rich media ad, or added as needed when the affiliate added the insertion codes to additional web pages. If a page containing an insertion code does not have its URL entered in the affiliate database entry, the management system can be set to display whatever the system operator chooses, such as a default ad or warning. Depending on the affiliate's level, URLs can be the root level, (www.domain.com), sub dirs (www.domain.com/files) or page specific such as (www.domain.com/index2.html). The management system can track every request and uses this information to send corresponding replies to the surfer browser and enforce limitations. The management system tracks every insertion code separately, and all requests from insertion codes have their own history. The management system tracks every surfer (using cookies) separately and every surfer has their own history. If surfer uses several browsers, the management system will have several history files for this surfer. For example, the management system may check surfer's history and find video clips were shown. The management system chooses next video clip depending on content area code rules, and affiliate settings and limits. If a surfer or someone attempting to circumvent the management system tries to call a rich media ad or its components directly, the managements system can be set to display whatever the system operator chooses, such as a default ad or warning.

The management system will detect the IP address of all users who access the admin area by extracting data contained in the web browser envelope. For example Internet Explorer using REMOTE_ADDR, or transmitted by the desktop application, and record that IP address, the login time, the username and password used and the account number accessed. Accounts can be monitored and reports created for security purposes, as well as to provide additional security measures, such as limiting access to an account to the IP used to create the account. The management system will also place a cookie file on the affiliate's pc. When a webpage containing a management system insertion code is displayed, if a cookie exists the data is sent back to the management system and compared to the data on file for the insertion code. If the management system determines that the visitor to the page the insertion code is on is the affiliate associated to that code, the management system will query the configuration settings to determine if clicks or impressions from the affiliate should be counted. The system operator is also able to set values in the security settings that will alert the system operator when the affiliate reaches these values, or automatically suspend the affiliate's account if activated. These include: alert at impressions over X, alert at click through ratios per ad lower than X, and alert at bandwidth over X.

Although an exemplary embodiment of the invention has been described above by way of example only, it will be understood by those skilled in the field that modifications may be made to the disclosed embodiment without departing from the scope of the invention.

We claim:

1. A method of managing advertisement content on websites, comprising:
a) storing website information, rich media ads, video elements, and graphic elements of one or more sponsors in an advertising content management system (ACMS) server which runs an advertising content management system;
b) allowing affiliates to create advertisements of selected sponsors using the stored website information, rich media ads, video elements, and graphic elements and to select URL addresses of websites on which the advertisements will be displayed; and
c) associating an insertion code that corresponds to one or more advertisements created by an affiliate.

2. The method of claim 1, further comprising:
providing one or more ACMS websites; a sponsors server system and one or more sponsors websites; and an affiliates server system and one or more affiliates websites.

3. The method of claim 2, further comprising:
providing a database associated with the ACMS server, and user devices adapted to access the affiliates websites over a communications network.

4. The method of claim 3, further comprising:
providing one or more ACMS websites adapted to connect to the communications network from the target devices independently of the sponsor server system and sponsor server websites.

5. The method of claim 4, further comprising:
administering advertising content management settings using a desktop application and transmitting the settings directly to the advertising content management system server via the communications network.

6. The method of claim 3, wherein any one or more of the ACMS server system, the sponsors server system, and the affiliates server system directly communicate, on a server-to-server basis, with servers associated with target devices through the communications network, bypassing the ACMS websites, the sponsors websites, and the affiliates websites.

7. The method of claim 6, further comprising:
publishing web pages by the sponsors server that are viewable to the target devices via the communications network.

8. The method of claim 7, further comprising:
publishing web pages by the affiliates server viewable to the target devices via the communications network.

9. The method of claim 1, wherein the ACMS server communicates directly with the sponsors server.

10. The method of claim 9, further comprising:
providing a sponsors server system and one or more sponsors websites, and an affiliates server system and one or more affiliates websites.

11. The method of claim 10, wherein the sponsors server system and the affiliates server system communicate directly, on a server-to-server basis, with servers associated with target devices through the communications network.

12. The method of claim 1, further comprising:
providing an insertion code unique to the advertisement created by the affiliate.
